(19) United States
(12) Patent Application Publication
(10) Pub. No.: US 2024/0289053 A1
(43) Pub. Date: Aug. 29, 2024

(54) DATA TYPE IDENTIFICATION SCHEMES FOR MEMORY SYSTEMS

(71) Applicant: Micron Technology, Inc., Boise, ID (US)

(72) Inventor: Giuseppe Cariello, Boise, ID (US)

(21) Appl. No.: 18/443,083

(22) Filed: Feb. 15, 2024

Related U.S. Application Data
(60) Provisional application No. 63/447,828, filed on Feb. 23, 2023.

(51) Int. Cl. G06F 3/06

(52) U.S. Cl. CPC G06F 3/0659; G06F 3/0604; G06F 3/064; G06F 3/0683

(57) ABSTRACT

Methods, systems, and devices for data type identification schemes for memory systems are described. A memory system may transfer data from one block of memory cells to another based on an indication of a characteristic of the data, such as a data type, a validity characteristic, or a data temperature. For example, data associated with a relatively longer validity duration may be prioritized for transfer to another block prior to data associated with a relatively shorter validity duration. An indication of a characteristic of the data may be received from a host system, and may be stored at the memory system in an entry of a physical-to-logical (P2L) table, or in accompanying metadata, or both. An indication of a data characteristic (e.g., a stream ID) may be maintained with the data throughout a validity duration of the data (e.g., through multiple flush or other transfer operations).

### CROSS REFERENCE

The present Application for Patent claims priority to and the benefit of U.S. Provisional Application No. 63/447,828 by Cariello et al., entitled “DATA TYPE IDENTIFICATION SCHEMES FOR MEMORY SYSTEMS,” filed Feb. 23, 2023 assigned to the assignee hereof, and is expressly incorporated by reference in its entirety herein.

### TECHNICAL FIELD

The following relates to one or more systems for memory, including data type identification schemes for memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 illustrates an example of a system that supports data type identification schemes for memory systems in accordance with examples as disclosed herein.

FIGS. 2A through 2D illustrate examples of data flow diagrams that support data type identification schemes for memory systems in accordance with examples as disclosed herein.

FIG. 3 illustrates an example of a media management configuration that supports data type identification schemes for memory systems in accordance with examples as disclosed herein.

FIG. 4 illustrates an example of a media management configuration that supports data type identification schemes for memory systems in accordance with examples as disclosed herein.

FIG. 5 illustrates a block diagram of a memory system that supports data type identification schemes in accordance with examples as disclosed herein.

FIG. 6 illustrates a flowchart showing a method or methods that support data type identification schemes for memory systems in accordance with examples as disclosed herein.

### DETAILED DESCRIPTION

Some memory systems may include sets of memory cells (e.g., blocks) configured for different storage densities (e.g., blocks configured for storing different quantities of logic states per memory cell). For example, a memory system may include one or more higher-density blocks that include multiple-level memory cells (e.g., triple-level memory cells, quad-level memory cells) and one or more lower-density blocks that include single-level memory cells. In some cases, writing information to relatively higher-density memory cells may be less efficient (e.g., more time-consuming, more energy-consuming, more processor-intensive) than writing information to relatively lower-density memory cells. Accordingly, some memory systems may perform operations (e.g., media management operations) to selectively write or transfer data to relatively higher-density blocks (e.g., if processing resources for such write operations are available). For example, a memory system may initially store information at a relatively lower-density block (e.g., a block including a configuration of single-level memory cells, a buffer, a cache) and may determine to transfer the information from the relatively lower-density block to a relatively higher-density block (e.g., a block including a configuration of multiple-level memory cells) to store valid data more compactly and increase an amount of available space. However, operations to selectively write or transfer data to higher-density blocks may not account for a characteristic of the data (e.g., a data type, a validity characteristic, a data temperature), which may result in resources being allocated for the transfer of data that may be invalidated after a relatively short duration.

In accordance with examples as described herein, a memory system may transfer data between blocks based on an indication of a characteristic of the data. For example, data associated with a relatively longer validity duration (e.g., a relatively lower temperature, relatively static data) may be prioritized for transfer to another block prior to data associated with a relatively shorter validity duration (e.g., a relatively hotter temperature, relatively transient data). An indication of a characteristic of the data may be stored in an entry of a physical-to-logical (P2L) table, or in accompanying metadata, or both. For example, a memory system may store data characteristic information in a P2L table, where each physical address of the memory system may correspond to a line in the P2L table that includes an indication of the data characteristic (e.g., for a codeword stored at the physical address). Additionally, or alternatively, each codeword stored by a memory system may include (e.g., as a portion of bits in the codeword, in metadata) an indication of the data characteristic for data of the codeword. An indication of a data characteristic (e.g., a stream ID) may be maintained (e.g., stored, transferred, tracked) with the data throughout a validity duration of the data (e.g., through multiple data transfer operations). By maintaining an indication of a data characteristic with the data, groups of data with a same data characteristic may be managed more effectively. For example, a memory system may open one or more destination blocks (e.g., target blocks) and select data with a given characteristic for transferring to a corresponding destination block (e.g., as part of a garbage collection operation), among other media management techniques, which may improve performance characteristics of the memory system such as latency, power consumption, storage availability, write amplification, and others.

Features of the disclosure are illustrated and described in the context of systems that relate to data type identification schemes for memory systems. Features of the disclosure are further illustrated and described in the context of data flow diagrams, media management configurations, apparatuses, and flowcharts that relate to data type identification schemes for memory systems.

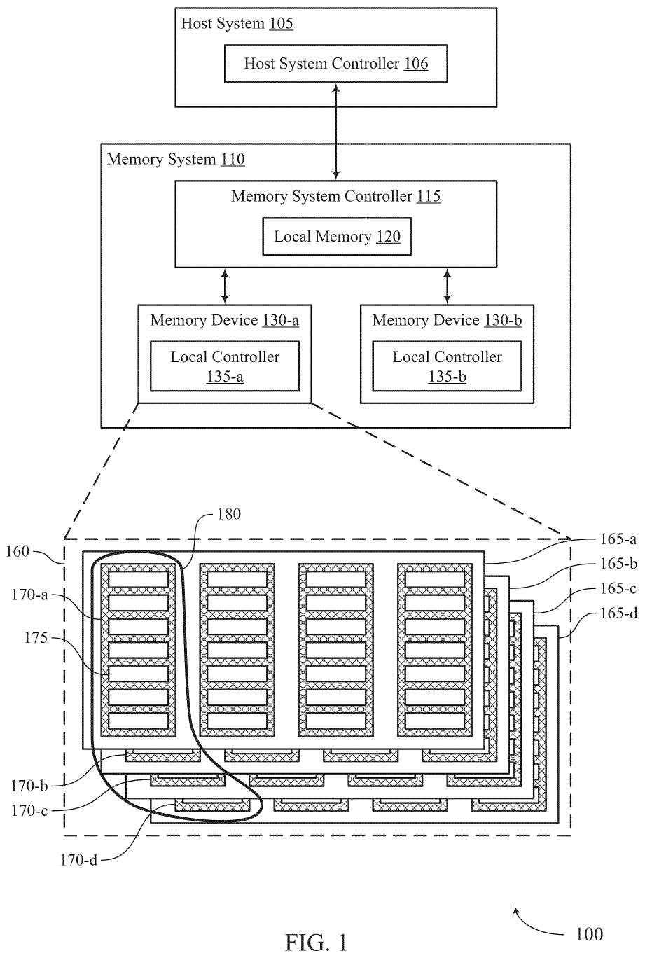

FIG. 1 illustrates an example of a system 100 that supports data type identification schemes for memory systems in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table, a P2L mapping table, or both, to associate the logical address (e.g., LBA) for the data with the new, valid block 170 rather than the old, invalid block 170. In some cases, such copying and remapping may be performed instead of erasing and rewriting the entire old block 170 due to latency or wear out considerations, for example. In some cases, one or more copies of an L2P mapping table, a P2L mapping table, or both, may be stored within the memory cells of the memory device 130 (e.g., within one or more blocks 170 or planes 165) for use (e.g., reference and updating) by the local controller 135 or memory system controller 115.

In some cases, L2P mapping tables, P2L mapping tables, or both, may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has not been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some examples, a memory system 110 may include sets of memory cells (e.g., blocks 170, virtual blocks 180) that are configured for different storage densities (e.g., blocks capable of storing different quantities of logic states per memory cell). For example, a memory system 110 may include one or more relatively higher-density blocks (e.g., blocks 170, virtual blocks 180) that include multiple-level memory cells (e.g., TLCs, QLCs) and one or more relatively lower-density blocks that include SLCs or less-dense multiple-level cells. In some cases, writing information to relatively higher-density cells may be less efficient than writing information to relatively lower-density cells. Accordingly, a memory system 110 may be configured to perform operations (e.g., media management operations) to selectively write or transfer data to higher-density blocks (e.g., if processing resources for such write operations are available). For example, a memory system 110 may initially store information at a relatively lower-density block (e.g., a block including a configuration of single-level memory cells, a buffer, a cache) and may determine to transfer the information from the relatively lower-density block to a relatively higher-density block (e.g., a block including a configuration of multiple-level memory cells) if the lower-density block becomes full.

In accordance with examples as described herein, a memory system 110 may transfer data between blocks (e.g., between blocks 170, between virtual blocks 180) based on an indication of a characteristic of the data. For example, data associated with a relatively longer validity duration (e.g., relatively static data, relatively lower-temperature data) may be prioritized for transfer to another block prior to data associated with a relatively shorter validity duration (e.g., relatively transient data, relatively hotter-temperature data). An indication of a characteristic of the data may be stored in an entry of a P2L table, or in accompanying metadata, or both. For example, a memory system 110 may store data characteristic information in a P2L table, where each physical address of the memory system may correspond to a line in the P2L table that includes an indication of the data characteristic for a codeword stored at the physical address. Additionally, or alternatively, each codeword stored by a memory system 110 may include (e.g., as a portion of bits in the codeword, in metadata) an indication of the data characteristic for data of the codeword. An indication of a data characteristic (e.g., a stream ID) may be maintained (e.g., stored, transferred, tracked) with the data throughout a validity duration of the data (e.g., through multiple transfer operations). By maintaining an indication of a data characteristic with the data, groups of data with a same data characteristic may be managed more effectively by a memory system 110. For example, a memory system 110 may open one or more destination blocks (e.g., target blocks) and select data with a given characteristic for transferring to a corresponding destination block (e.g., as part of a garbage collection operation), among other media management techniques, which may improve performance characteristics of the memory system 110 such as latency, power consumption, storage availability, write amplification, and others.

The system 100 may include any quantity of non-transitory computer readable media that support the described data type identification schemes. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

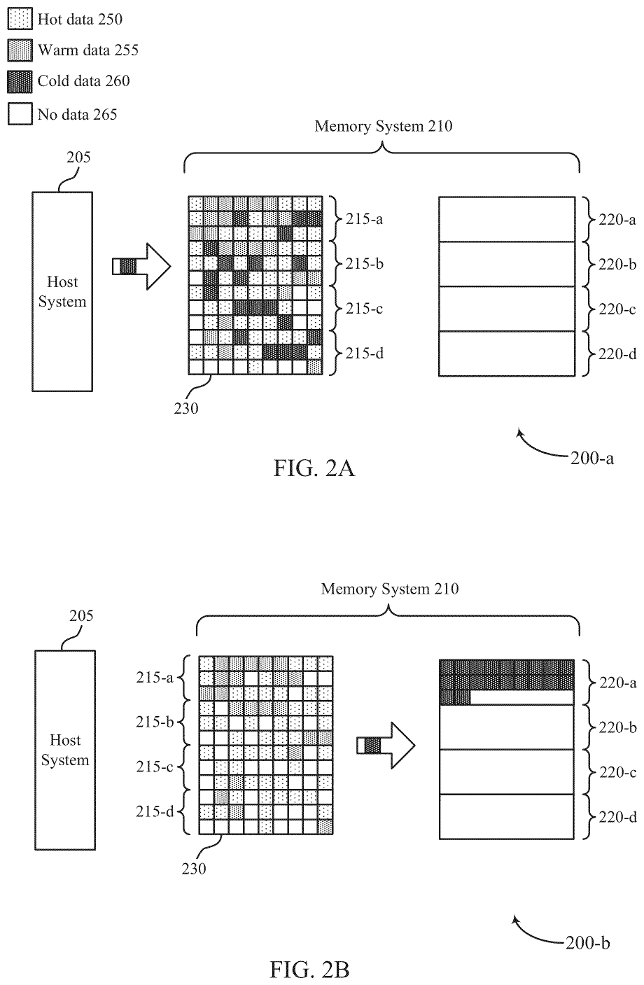

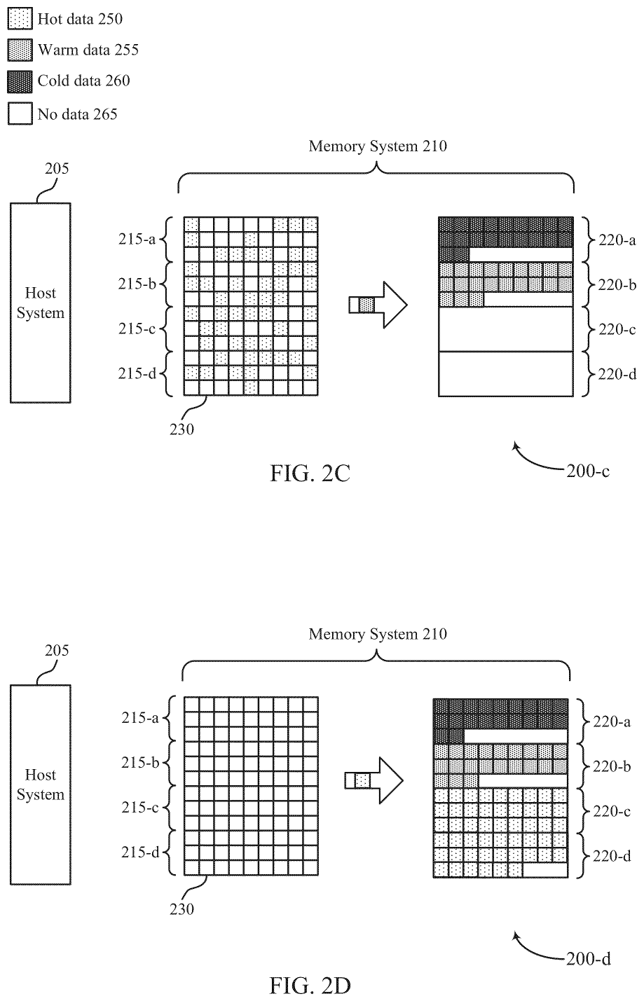

FIGS. 2A through 2D illustrate examples of data flow diagrams 200 that support data type identification schemes for memory systems in accordance with examples as disclosed herein. Each data flow diagram 200 may illustrate a stage of an operation that includes transferring data from one or more blocks 215 to one or more blocks 220. The data flow diagrams 200 may be implemented by a system 100. Each data flow diagram 200 may illustrate a host system 205 and a memory system 210, which may be examples of a host system 105 and a memory system 110, respectively. The memory system 210 may include one or more memory devices partitioned into one or more blocks 215 (e.g., source blocks, cache blocks, buffer blocks) and one or more blocks 220 (e.g., target blocks). As described herein, blocks 215 and blocks 220 may be examples of blocks 170, or virtual blocks 180, or a combination thereof.

The described techniques for transferring data may be performed using various characteristics to categorize data into different sets (e.g., by data type, by data characteristic). For example, groups of data may be associated with a validity characteristic, such as a validity duration characteristic, which may be associated with a duration for which data is anticipated to be valid at the memory system 210, or associated with a rate of invalidation of the data, among other characteristics of data validity. For example, a validity duration may be associated with an expected or average duration from a time that the data is written, generated, or stored (e.g., in one or more blocks 215) to a time that the data becomes invalid (e.g., eligible for erasure). Such characteristics may be referred to as a data temperature, for which relatively colder data may be relatively static data (e.g., data that is relatively unlikely to change) that is associated with a relatively longer validity duration, and relatively warmer data may be relatively transient data (e.g., data that is relatively likely to change or data that is more likely to be used for a short duration) associated with a relatively shorter validity duration. Flow diagrams 200, for example, illustrate techniques with three data characteristics, including hot data 250, warm data 255, and cold data 260, corresponding to progressively longer validity durations.

Although the described techniques refer to hot data 250, warm data 255, and cold data 260, different data temperatures or different granularities (e.g., different quantities of two or more categories) may be implemented in accordance with the described techniques. For example, data may have any temperature of a range of temperatures, where each temperature corresponds to a validity duration or validity duration range for the data. Further, although the described techniques illustrate an example of using data temperature associated with a validity duration characteristic to distinguish groups of data, groups of data may be separated by other characteristics, which may be generally referred to as data characteristics or data types. For example, one data type may be associated with streaming or other relatively temporary data types (e.g., corresponding to relatively transient data), whereas another data type may be associated with operating system, archive, or other relatively persistent data types. (e.g., corresponding to relatively static data).

Although examples described with reference to FIGS. 2A through 2D refer to a prioritization scheme (e.g., prioritizing transfer of cold data 260 before transfer of hot data 250) various other prioritization schemes for data transfer between one or more blocks 215 and one or more blocks 220 may be implemented in accordance with the described techniques. For example, in some cases, multiple data types (e.g., hot data 250 and cold data 260) may be transferred from one or more blocks 215 to one or more blocks 220 concurrently. Additionally, or alternatively, hot data 250 or warm data 255 may be transferred to one or more blocks 220 prior to cold data 260. In some cases, transferring cold data 260 to one or more blocks 220 may not be prioritized (e.g., performed first) and data may be transferred according to other prioritization schemes.

FIG. 2A illustrates an example of a data flow diagram 200-a that supports data type identification schemes for memory systems in accordance with examples as disclosed herein. Techniques are described for transferring data from one or more blocks 215 to one or more blocks 220 based on the type of data stored in one or more blocks 215. The data flow diagram 200-a illustrates a portion of such a transfer operation. The techniques described herein may be applied (e.g., by the memory system 210) for transferring data between blocks of any storage density configurations. In some examples of the described techniques, the blocks 215 may be configured with a relatively lower storage density (e.g., associated with SLCs, MLCs, or TLCs) and the blocks 220 may be configured with a relatively higher storage density (e.g., associated with MLCs, TLCs, or QLCs), in which case the illustrated transfers may be applicable to a flush operation (e.g., a cache flush, a buffer flush). In some other examples of the described techniques, the blocks 215 and the blocks 220 may be configured with the same storage density, in which case the illustrated transfers may be applicable to a garbage collection operation, or a wear leveling operation, among other media management operations. However, the described techniques may be implemented with other storage density configurations and operation nomenclature.

The memory system 210 may include a first portion (e.g., including the one or more blocks 215) and a second portion (e.g., including the one or more blocks 220). The one or more blocks 215 may be an example of an SLC portion of memory. For example, the first portion of the memory system 210 may include memory cells configured to each store one bit of information. The one or more blocks 220 may be an example of a portion of memory including multiple-level cells (e.g., MLCs, TLCs, QLCs). Each multiple-level cell may be configured to store two or more bits of data. In some cases, multiple-level cells may provide greater storage density relative to SLCs but may, in some cases, involve narrower read or write margins, greater complexities for supporting circuitry, and increased times for reading data and writing data.

In some cases, such as scenarios with nominal traffic to the memory system 210 (e.g., if communications received by the memory system 210 fail to satisfy a threshold), the memory system 210 may write data directly into one or more blocks 220 (e.g., into any combination of multiple-level cells), which may reduce write amplification (WA) and increase a total bytes written (TBW) metric, thereby extending the life of the memory system 210. Writing data directly in one or more blocks 220, however, may involve longer operations than writing data into blocks 215. For scenarios in which the memory system 210 receives a relatively high volume of data or write commands in a short duration, processing or other resources of the memory system 210 may become saturated, and latency for performing access operations (e.g., write operations, read operations) may increase. In some implementations, the memory system 210 may include a write booster mode to improve performance during such scenarios.

In a write booster mode, the memory system 210 may initially write data received from the host system 205 into a buffer, such as into one or more blocks 215 (e.g., when blocks 215 are configured with a relatively lower storage density, as a cache). Because writing to SLCs may be performed more quickly than writing to multiple-level cells, using the write booster mode may reduce latency associated with performing access commands. After writing data to one or more blocks 215, the memory system 210 may transfer the data to one or more blocks 220 as a background operation that has a reduced impact on the performance of the memory system 210. For example, the memory system 210 may identify an idle state, among other conditions, and transfer the information from one or more blocks 215 to one or more blocks 220 during the idle state. Such transfer operations, however, may increase the WA experienced by the memory system 210 and reduce a TBW metric.

In some examples, the host system 205 may control whether the memory system 210 operates in a write booster mode and may transmit signaling to the memory system 210 to enter or exit the write booster mode. For example, the memory system 210 may receive a command from the host system 205 that instructs the memory system 210 to write the data into an allocated buffer (e.g., one or more blocks 215) for faster performance. In some examples, the memory system 210 may control whether the memory system 210 operates in the write booster mode.

The memory system 210 may perform various evaluations that support performing a transfer of the data stored in one or more blocks 215 to one or more blocks 220. For example, the memory system 210 may determine whether an amount of space available at the memory system 210 satisfies a threshold, which may include the memory system 210 determining a quantity of available blocks 215, or pages 230 thereof, or some other measure of available space (e.g., space available in a cache of relatively lower-density memory cells, space available in a write booster cache). If the amount of available space satisfies the threshold, the memory system 210 may proceed with transferring valid data out of one or more blocks 215, which may support blocks 215 being made available for erasure, or to be otherwise made available to store new data. Additionally, or alternatively, the memory system 210 may trigger a transfer of data from one or more blocks 215 to one or more blocks 220 in response to an operating state or condition of the memory system 210 (e.g., an explicit host request to free up the write booster buffer, operation or configuration in an idle state, a hibernate state, or another low-power state, a quantity of commands received from the host system 205 within a duration being below a threshold). In some examples, an operation to transfer data from blocks 215 to blocks 220 may be referred to as a flush operation, among other names.

In some examples, the memory system 210 may select blocks 215 based on an amount of data in respective blocks 215. For example, a memory system 210 may prioritize blocks having relatively lower amounts of valid data, which may support faster transfer operations that make storage space available more quickly (e.g., based on a greedy policy). Additionally, or alternatively, in some examples, a memory system 210 may be configured to transfer data from one or more blocks 215 to one or more blocks 220 based on a temperature of the data, such as in accordance with a grouping of hot data 250, warm data 255, and cold data 260.

Hot data 250 may refer to data that is frequently invalidated, erased, or overwritten. Examples of hot data 250 may include data used by real-time analytics, streaming data, sensor data, or other types of data. In some cases, to improve performance of the memory system 210, hot data 250 may be stored in memory locations (e.g., memory blocks) that are quickly accessible by the host system 205, such as a buffer (e.g., one or more blocks 215). Cold data 260 may refer to data that is infrequently invalidated, erased, or overwritten as compared to hot data 250. That is, hot data 250 may become invalid more quickly than cold data 260. Examples of cold data 260 may include data that is archived (e.g., for compliance reasons), historical data, backup data, inactive data, data for an operating system, or other data types. In some cases, to improve performance, cold data 260 may be stored at memory locations with relatively slow access, which may conserve processing resources. Warm data 255 may refer to data this invalidated, erased, or overwritten more frequently than cold data 260 but less frequently than hot data 250. In some cases, hot data 250 may be invalidated in seconds while cold data 260 or warm data 255 may remain valid for minutes, hours, or longer.

Blocks 215 and blocks 220 may each include a plurality of pages 230. In some examples, a page 230 may be subdivided into multiple logical blocks, or other data units, which may be associated with one or more streams. For example, a page 230 may refer to 16 kB of storage space (plus spare space, in some examples) and may include logical blocks each associated with a 4 kB storage size, although other storage sizes and subdivisions may be implemented. In some examples, a logical block may be referred to as a virtual page or a physical translation unit (PTU). In some examples, a logical block (e.g., plus metadata, error correction code (ECC) bits, or both, where applicable) may form a codeword. The data flow diagram 200-a may illustrate respective characteristics (e.g., validity duration characteristics, data temperatures, stream IDs) for each page 230 (e.g., whether each page stores hot data 250, warm data 255, cold data 260, or no data 265). For example, some of the pages 230 may store hot data 250, some of the pages 230 may store warm data 255, some of the pages 230 may store cold data 260, and some of the pages 230 may store no data 265 (e.g., may be empty, may be written with invalid data) as shown by the shading of the pages. Although the described techniques for data characterization and transfer operations are illustrated at a granularity of pages 230, the described techniques also may be implemented in accordance with other granularities, such as a granularity of a logical block or codeword, among other examples.

A characteristic for respective data may be identified by one or more indicators (e.g., a stream ID), which may be determined at or communicated by a host system 205, a memory system 210, or both. In some examples, the host system 205 may determine the characteristic of the data being stored and may transmit an indication of the characteristic of the data to the memory system 210. The host system 205 may use information about the source of the data, an application associated with the data, or other factors to determine the characteristic of the data. An indication of a data characteristic transmitted by the host system 205 may be explicitly signaled using one or more bits. In some examples, an indication transmitted by the host system 205 may be encoded to indicate a characteristic of the data and other information. In such examples, the indication may be decoded by the memory system 210 and the memory system 210 may determine the characteristic of the data and the other information encoded in the indication.

In some examples, an indication of a data characteristic may be implicitly signaled by the host system 205. In such examples, the host system 205 may provide information about the data to be written to the memory system 210 and the memory system 210 may use that information to determine the characteristic of the data. The indication may be transmitted as part of a write command, as part of the data associated with the write command, as a separate command, as separate metadata, or a combination thereof. In some examples, the memory system 210 determine the type of the data being stored using any of the techniques described herein. In some examples, indication may be an example of a stream ID or may be an example of one or more bits of a stream ID associated with the data or the write command.

In some examples, an indication of a characteristic of data may be stored with the data in one or more blocks 215. In such examples, the memory system 210 may identify the type of the data stored in a page 230 of a block 215 by the associated indication. In some examples, memory system 210 may maintain a mapping of the pages 230 included in blocks 215. The mapping may indicate respective characteristics for data stored in a particular page 230. The mapping of the blocks 215 may be based on pages 230 of the blocks 215 or any other subdivision of memory (e.g., physical blocks, virtual blocks, sections, planes, memory cells, or other divisions). Pages 230 are used as an illustrative example of a division of blocks (e.g., blocks 215, blocks 220), but other divisions of memory—such as blocks, sections, planes, memory cells, or other divisions—may be used in accordance with the described techniques.

Techniques are described for a memory system 210 to transfer data from one or more blocks 215 to one or more blocks 220 based on a characteristic of the data stored in one or more blocks 215. In some examples, data having a first characteristic may be transferred from one or more blocks 215 to one or more blocks 220 before data having a second characteristic may be transferred from one or more blocks 215 to one or more blocks 220. Prioritizing the transfer of data from one or more blocks 215 to one or more blocks 220 based on the characteristic of the data may reduce WA or increase a TBW metric associated with the memory system 210. For example, cold data 260 may be transferred before warm data 255 or hot data 250. In some such examples, hot data 250 may be invalidated or altered before transferring to one or more blocks 220 thus reducing an amount of data transferred.

FIG. 2B illustrates an example of a data flow diagram 200-b that supports data type identification schemes for memory systems in accordance with examples as disclosed herein. Techniques are described for transferring data from one or more blocks 215 to one or more blocks 220 based on the type of data stored in the one or more blocks 215 (e.g., based on a data characteristic, such as data temperature). The data flow diagram 200-b illustrates a portion of such a transfer operation. For example, the data flow diagram 200-b illustrates transferring cold data 260 from one or more blocks 215 to one or more blocks 220.

The one or more blocks 215 (e.g., a buffer) may be configured to store data in SLCs until the data can be transferred to one or more blocks 220. Such a configuration for the one or more blocks 215 may enable the memory system 210 to reduce latency associated with the memory system 210 writing data received from the host system 205, which may be implemented for conditions in which the host system 205 is transferring a large amount of data or issuing a large quantity of commands, among other examples. To support one or more blocks 215 being available to handle periods of high-traffic, the memory system 210 may periodically empty the one or more blocks 215 (e.g., flush data from the one or more blocks 215, erase data in the one or more blocks 215).

The memory system 210 may implement various criteria to determine how to flush the one or more blocks 215 (e.g., transfer data stored in the one or more blocks 215 to one or more blocks 220). In some cases, the memory system 210 may determine a time to flush the one or more blocks 215 that has a relatively small impact (e.g., no impact) on a latency to execute commands from the host system 205. In some cases, the memory system 210 may identify an idle condition to determine to flush the one or more blocks 215. In some cases, the memory system 210 may determine that a queue of commands from the host system 205 satisfies (e.g., is less than) a threshold. The memory system 210 may transfer data from one or more blocks 215 to one or more blocks 220 as part of a background operation with a small to minimal impact on latency performance seen by the host system 205.

In some examples, the memory system 210 may transfer some or all of the data from one or more blocks 215 into one or more blocks 220 regardless of the type of the data stored in one or more blocks 215 (e.g., regardless of data temperature). For example, a flush or garbage collection operation in a NAND memory device may identify one or more source blocks (e.g., one or more blocks 215, one or more blocks 220) that have an amount of valid data that is below a threshold. The flush or garbage collection may then transfer valid data from the source block to a target block and erase the source block. However, when data characteristics are not considered, such procedures may unnecessarily increase the WA and reduce TBW of the memory system 210. For example, hot data 250 may be invalidated relatively quickly, and may not warrant being flushed or otherwise transferred from blocks 215 to blocks 220. Instead, to reduce WA and increase TBW in some examples, it may be preferable to allow hot data 250 to remain in blocks 215 until the hot data 250 is invalidated and may be erased from the blocks 215 without being transferred to blocks 220. Additionally, or alternatively, it may be preferable to transfer data to blocks 220 that are each allocated to a respective data type (e.g., allocated to a data temperature), such that data in respective data blocks 220 is relatively more likely to remain valid for a similar duration.

Techniques are described for performing a coordinated transfer of data stored in one or more blocks 215 to one or more blocks 220 based on the type of data (e.g., the data temperature) stored in the one or more blocks 215. The coordinated transfer of data may include using a first set of criteria to transfer cold data 260, using a second set of criteria to transfer warm data 255, and using a third set of criteria to transfer hot data 250. In some examples, the coordinated transfer may be an example of a cascaded transfer operation that transfers different types of information at different times (e.g., sequentially). In some other examples, the coordinated transfer may be an example of a parallel transfer operation that transfers different types of information during overlapping times (e.g., concurrently).

The memory system 210 may determine that the first set of criteria for transferring cold data 260 is satisfied. The first set of criteria may include a determination of whether the memory system 210 is in a condition to transfer data without adverse impact on the latency for performing commands received from the host system 205. For example, the first set of criteria may include determining that the memory system 210 is in an idle state or that a quantity of commands (e.g., in a queue) received from the host system 205 satisfies (e.g., is below) a threshold. The first set of criteria also may include determining whether cold data 260 is present in one or more blocks 215, or whether a quantity of the cold data 260 stored in one or more blocks 215 satisfies a threshold. If cold data 260 is not present, then the first set of criteria may not be satisfied. The first set of criteria also may include determining whether the quantity of pages 230 of one or more blocks 215 that are storing valid data satisfies a threshold. An example of such a threshold may include that 50% of a total quantity of pages 230 for a block 215 store valid data. Other examples of the threshold may include any validity percentage for one or more blocks 215.

In response to determining that the first set of criteria is satisfied, the memory system 210 may transfer the cold data 260 from one or more blocks 215 to one or more blocks 220. In some cases, the memory system 210 may transfer the cold data 260 until the first set of criteria are no longer satisfied. In some cases, the memory system 210 may transfer the cold data 260 until all of the cold data 260 is transferred out of one or more blocks 215. In some cases, the memory system 210 may transfer the cold data 260 until the percentage full of one or more blocks 215 satisfies a threshold or until a quantity of cold data 260 satisfies a threshold.

In response to the cold data 260 being transferred, the memory system 210 may indicate that the pages 230 of one or more blocks 215 that formerly stored the cold data 260 are invalid (e.g., available for erasure). For example, the memory system 210 may add those pages 230 to a free page list for one or more blocks 215. In some cases, the memory system 210 may determine whether writing the quantity of the data to one or more blocks 220 is successful. If the writing is successful, the memory system 210 may indicate that the data stored in the various pages in one or more blocks 215 is invalid. In some cases, the memory system 210 may not apply redundant array of independent node protection (e.g., redundant array of independent NAND (RAIN) protection) to the data as part of writing the data into one or more blocks 220. Such cases may occur because the memory system 210 may refrain from erasing (e.g., releasing, overwriting) the data stored in the one or more blocks 215 until it confirms that the copy of the data is successfully stored in one or more blocks 220.

The memory system 210 may store the cold data 260 in a block 220-a (e.g., a block 220 allocated to cold data 260) which may, in some examples, include one or more multiple-level cells. The transfer operation may result in cold data 260 being sequentially grouped in one or more blocks 220. In some examples, the memory system 210 may transfer the cold data 260 to certain blocks 220 because it may be less likely that such blocks would be a target for a garbage collection operation than a block that stores warm data 255 or hot data 250. By grouping cold data 260 in a same block (e.g., the block 220-a), data of the block 220 may remain valid for a similar duration, which may reduce a quantity of data transferred as part of later garbage collection operations. In some examples, cold data 260 may be stored in a QLC block 220 while other types of data may be stored in TLC blocks 220 or SLC blocks 220. In some other examples, cold data 260 or warm data 255 may be stored in QLC blocks 220 while hot data 250 may be stored in TLC blocks 220. While QLC blocks and TLC blocks are referenced as illustrative examples, any density of blocks 220 may be used.

FIG. 2C illustrates an example of a data flow diagram 200-c that supports data type identification schemes for memory systems in accordance with examples as disclosed herein. For example, the data flow diagram 200-c illustrates transferring warm data 255 from one or more blocks 215 to one or more blocks 220.

The memory system 210 may determine that the second set of criteria for transferring warm data 255 is satisfied. The second set of criteria may include a determination of whether the memory system 210 is in a condition to transfer data without adverse impact on the latency for performing commands received from the host system 205. For example, the second set of criteria may include determining that the memory system 210 is in an idle state or that a quantity of commands received from the host system 205 satisfies a threshold. The second set of criteria may also include determining whether warm data 255 is present in one or more blocks 215, or whether a quantity of the warm data 255 stored in one or more blocks 215 satisfies a threshold. If warm data 255 is not present, then the second set of criteria may not be satisfied. The second set of criteria may also include determining whether cold data 260 is present in one or more blocks 215. If cold data 260 is present, the memory system 210 may first transfer the cold data 260 before transferring the warm data 255. The second set of criteria may also include determining whether the quantity of pages 230 of one or more blocks 215 that are storing valid data satisfy a threshold.

In response to determining that the second set of criteria is satisfied, the memory system 210 may transfer the warm data 255 from one or more blocks 215 to one or more blocks 220. In some cases, the memory system 210 may transfer the warm data 255 until the second set of criteria are no longer satisfied. In some cases, the memory system 210 may transfer the warm data 255 until the warm data 255 is transferred out of one or more blocks 215. In some cases, the memory system 210 may transfer the warm data 255 until a quantity of data stored in one or more blocks 215 (e.g., a percentage full) satisfies a threshold or until a quantity of warm data 255 satisfies a threshold.

In response to the warm data 255 being transferred, the memory system 210 may indicate that the pages 230 of one or more blocks 215 that formerly stored the warm data 255 are invalid. For example, the memory system 210 may add those pages 230 to a free page list associated with one or more blocks 215. In some cases, the memory system 210 may determine whether writing the quantity of the data to one or more blocks 220 is successful. If the writing is successful, the memory system 210 may indicate that the data stored in the various pages in one or more blocks 215 is invalid. In some cases, the memory system 210 may not apply redundant RAIN protection to the data as part of writing the data into one or more blocks 220. Such cases may occur because the memory system 210 may refrain from erasing the data stored in one or more blocks 215 until it confirms that the copy of the data is successfully stored in one or more blocks 220.

The memory system 210 may store the warm data 255 in a block 220-b (e.g., a block 220 allocated to warm data 255). The transfer operation may result in the warm data 255 being sequentially grouped in one or more blocks 220. By grouping warm data 255 in the same block 220, data of the block 220 may remain valid for a similar duration, which may reduce a quantity of data transferred as part of later garbage collection operations.

FIG. 2D illustrates an example of a data flow diagram 200-d that supports data type identification schemes for memory systems in accordance with examples as disclosed herein. For example, the data flow diagram 200-d illustrates transferring hot data 250 from one or more blocks 215 to one or more blocks 220.

The memory system 210 may determine that the third set of criteria for transferring hot data 250 is satisfied. The third set of criteria may include a determination of whether the memory system 210 is in a condition to transfer data without an adverse impact on the latency for performing commands received from the host system 205. For example, the third set of criteria may include determining that the memory system 210 is in an idle state or that a quantity of commands received from the host system 205 satisfies a threshold. The third set of criteria also may include determining whether hot data 250 is present in one or more blocks 215, or whether a quantity of the hot data 250 stored in one or more blocks 215 satisfies a threshold. If hot data 250 is not present, then the third set of criteria may not be satisfied. If the third set of criteria is satisfied, the memory system 210 may transfer hot data 250 from one or more blocks 215 to one or more blocks 220. In some cases, the memory system 210 may transfer the hot data 250 until the third set of criteria are no longer satisfied. In some cases, the memory system 210 may transfer the hot data 250 until the hot data 250 is transferred out of one or more blocks 215. In some cases, the memory system 210 may transfer the hot data 250 until a quantity of data in one or more blocks 215 satisfies a threshold or until a quantity of hot data 250 satisfies a threshold.

In response to the hot data 250 being transferred, the memory system 210 may indicate that the pages 230 of one or more blocks 215 that formerly stored the hot data 250 are invalid. For example, the memory system 210 may add those pages 230 to a free page list associated with one or more blocks 215. In some cases, the memory system 210 may determine whether writing the quantity of the data to one or more blocks 220 is successful. If the writing is successful, the memory system 210 may indicate that the data stored in the various pages in one or more blocks 215 is invalid. In some cases, the memory system 210 may not apply redundant RAIN protection to the data as part of writing the data into one or more blocks 220 at 285. Such cases may occur because the memory system 210 may refrain from erasing the data stored in one or more blocks 215 until it confirms that the copy of the data is successfully stored in one or more blocks 220.

In accordance with examples as described herein, an indication of a data characteristic may be stored in a manner that accompanies the data and supports coordinated transfers of the data. For example, the memory system 210 may store data characteristic information in a P2L table (e.g., associated with blocks 215, associated with blocks 220), where each physical address associated with a respective block or other unit may correspond to a line in the P2L table that includes an indication of the data characteristic for a codeword stored at the physical address. Additionally, or alternatively, codewords stored in pages 230 may include an indication of the data characteristic for data of the codeword (e.g., as a portion of bits in the codeword, in metadata). An indication of a data characteristic (e.g., a stream ID) may be maintained with the data throughout a validity duration of the data (e.g., through multiple transfer operations).

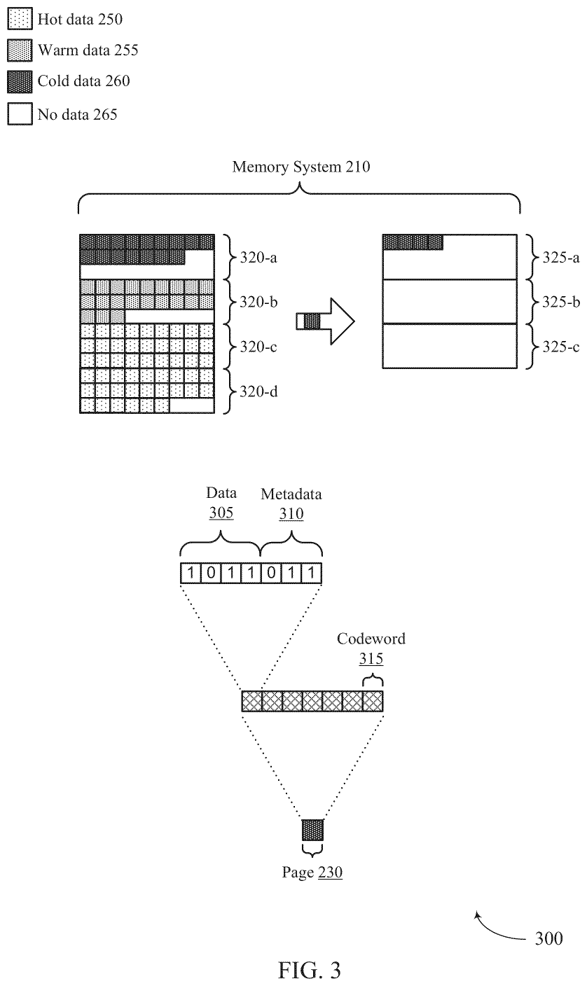

FIG. 3 illustrates an example of a media management configuration 300 that supports data type identification schemes for memory systems in accordance with examples as disclosed herein. For example, data of one or more pages 230 may be transferred between one or more blocks 320 and one or more blocks 325, where each of the blocks 320 or 325 may be an example of a block 170 or a virtual block 180. In some cases, transferring a page 230 may be performed as part of a media management operation, such as a flush operation, a garbage collection operation, or a wear leveling operation, among others. The media management configuration 300 may be implemented by a memory system 210, and may illustrate aspects of a transfer operation in which metadata 310 is used to maintain an indication of a characteristic of data 305.

In accordance with examples as disclosed herein, transfer operations may include reading a page 230 from a block 320 and writing data read from the page 230 to a block 325. In some cases, such transferring may include storing data read from a page 230 in a buffer (e.g., of local memory 120, in SRAM, not shown). For example, the memory system 210 may read a page 230 from one or more blocks 320, write at least a portion of the data to a buffer, and write data from the buffer to one or more pages of a block 325 (e.g., in response to a threshold capacity of the buffer being filled, if a quantity of pages 230 stored in the buffer satisfies a threshold).

In some examples, transferring information may be based on a validity of the information (e.g., whether the information is valid or invalid). For example, the memory system 210 may selectively transfer valid information from a block 320 to a block 325, so that the block 320 may be made available for storing new information (e.g., such that each page 230 of the block 320 may be marked as invalid and erased). In some cases, the memory system 210 may access a validity status for information from a storage location of the memory system 210, such as an L2P table or a PVT, which may be part of the same block 320 as the data, or otherwise associated with the data.

In some cases, information may be transferred based on a data characteristic (e.g., a data type, a data temperature), which may be indicated by a stream ID or other indicator in metadata 310. For example, the memory system 210 may select pages 230 storing valid information from one or more blocks 320, which may include the memory system 210 selecting one or more blocks 320 that include data with a specific characteristic. For example, the memory system 210 may prioritize transferring cold data 260 and may accordingly select the block 320-a, among other blocks 320 that include cold data 260, for a transfer operation (e.g., prior to selecting pages 230 from the blocks 320-b, 320-c, and 320-d). In some cases, the memory system 210 may determine a characteristic for the information (e.g., a temperature for the information) from metadata 310. In some cases, the memory system 210 may read the metadata 310 during or after an operation to write the information to a buffer.

The memory system 210 may write transfer information to one or more blocks 325 in response to a size of the information (e.g., in SRAM, in a block 320) satisfying a threshold. For example, the memory system 210 may be configured to write specific quantities of pages 230 (e.g., specific burst sizes, specific granularities), such as a quantity of pages 230 in a block 325. A threshold write granularity for the memory system 210 may include any quantity of pages 230, or other data granularity, which may be configured to support efficient transfer operations or may be dictated by the physical characteristics of the storage media. In some cases, the memory system 210 may transfer a relatively small quantity of information (e.g., a single page 230, a set of multiple pages 230 that are written together in a multiple-level page 175, such as a multiple-level page 175 of a block 325) from SRAM to one or more blocks 325 if the threshold write granularity (e.g., a single page 230) is satisfied. In some cases, a buffer may be dynamically allocated to different stream IDs, which may reduce a likelihood that deadlocks will occur and may improve storage efficiency at the SRAM.

In some examples, metadata 310 may be stored with data 305, such as being stored in a same codeword 315 (e.g., of one or more codewords in a page 230). In some cases, the memory system 210 may receive at least a portion of metadata 310 from a host system 205 (e.g., with data 305). Additionally, or alternatively, the memory system 210 (e.g., firmware of the memory system 210) may generate at least a portion of metadata 310 associated with data 305. As described herein, each block of the memory system 210 may store a quantity of pages 230, which may include a quantity of codewords 315. Each codeword 315 may include one or more bits for data 305 and one or more bits for metadata 310, which may be stored contiguously. Although the media management configuration 300 shows an illustrative example of metadata 310 including three bits and data including four bits, metadata 310 may include any quantity of bits (e.g., 8 bits) and data 305 may include any quantity of bits (e.g., 4 kilobytes).

Although the media management configuration 300 illustrates metadata 310 corresponding to each codeword 315 (e.g., included in each codeword 315), metadata 310 also may be stored for, allocated to, or otherwise correspond to any division of information, such as a page 230. Accordingly, the memory system 210 may store metadata 310 for each page 230, each codeword 315, or both. As described herein, transfer operations that utilize metadata 310 may access or otherwise transfer information having various granularities. For example, the memory system 210 may transfer a page 230 of cold data 260 based on a stream ID for the pages 230, where the stream ID is indicated by metadata 310 for the page 230. In some other cases, the memory system 210 may transfer a codeword 315 of cold data 260 based on a stream ID for the codeword 315, where the stream ID is indicated by metadata 310 for the codeword 315.

Transferring data based on a stream ID may enable the memory system 210 to conserve processing resources by prioritizing the transfer of data 305 from cold to hot (e.g., transferring cold data 260 prior to warm data 255, and so on) or by refraining from transferring data with specific stream IDs (e.g., refraining from transferring hot data 250). For example, it may be advantageous for the memory system 210 to perform transfers (e.g., for flush operations, for garbage collection operations, for wear leveling operations) on cold data 260 prior to performing transfers on warm data 255 or hot data 250, either or both of which may become invalid before the cold data 260 becomes invalid. Accordingly, the memory system 210 may perform a transfer operation that includes reading a data characteristic from metadata 310 to evaluate whether to transfer a codeword 315, or to determine a target block 325 for a codeword 315, among other techniques. In some examples, such operations also may include reading information (e.g., one or more entries in an L2P table or a page validity table) that indicates which codewords 315 or which pages 230 are valid. The memory system 210 may then write information (e.g., one or more codewords 315, one or more pages 230) that is valid to a block 325, which may be followed by marking one or more pages 230 of a block 320 as invalid or erasing a block 320.

In some cases that implement storing an indication of a data characteristic in metadata 310, the memory system 210 may open a respective block 325 for multiple data characteristics, such as a block 325 for each possible data characteristic or a block 325 for each data characteristic that may be stored in a selected source block 320, which may facilitate data separation at the memory system 210. For example, the memory system 210 may open a block 325-a for storing cold data 260, a block 325-b for storing warm data 255, and a block 325-c for storing hot data 250. In some cases, the memory system 210 may open multiple blocks 325 concurrently. For example, the memory system 210 may open blocks 325-a, 325-b, and 325-c concurrently (e.g., prior to reading one or more codewords 315, prior to reading metadata 310). By opening multiple blocks 325 concurrently, the memory system 210 may support an open block 325 for codewords 315 associated with each data characteristic that may be read from metadata 310, which may reduce occurrences of reading codewords 315 without transferring them and accordingly reduce transfer latency. In some other examples, a block 325 may be opened for some subset of data characteristics (e.g., a single block 325, a block 325 for cold data 260), in which case some codewords 315 read from a block 320 may be read, but not transferred to a block 325 (e.g., when a data characteristic read from metadata 310 of the codeword 315 does not match a data characteristic allocated to an open block 325), which may increase transfer latency but may reduce overhead associated with supporting a greater quantity of open blocks 325.

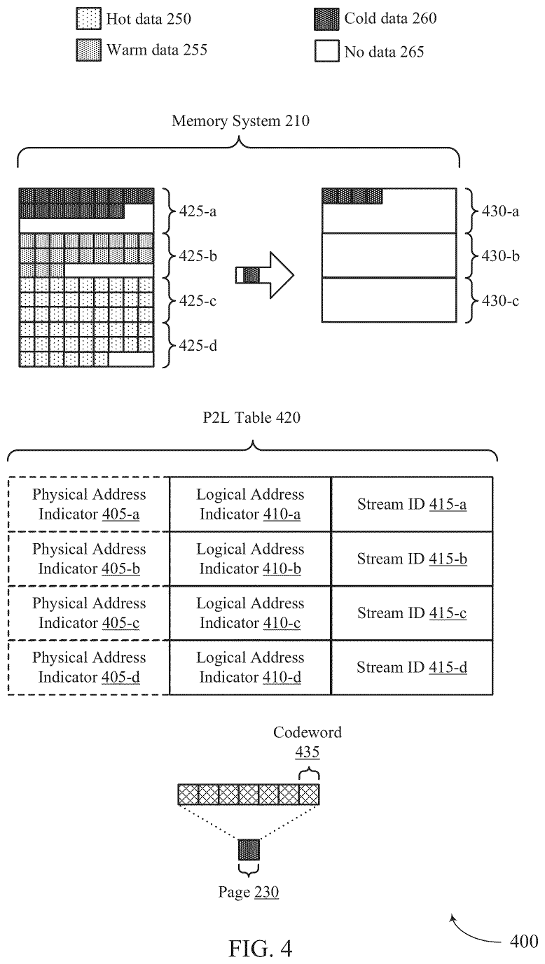

FIG. 4 illustrates an example of a media management configuration 400 that supports data type identification schemes for memory systems in accordance with examples as disclosed herein. For example, data of one or more pages 230 may be transferred between one or more blocks 425 and one or more blocks 430, where each of the blocks 425 or 430 may be an example of a block 170 or a virtual block 180. In some cases, transferring a page 230 may be performed as part of a media management operation, such as a flush operation, a garbage collection operation, or a wear leveling operation, among others. The media management configuration 400 may be implemented by a memory system 210, and may illustrate aspects of a data transfer operation in which a P2L table 420 is used to maintain an indication of a data characteristic (e.g., a stream ID 415).

In some cases, the memory system 210 may store a P2L table 420. For example, one or more blocks 425 may include a set of memory cells that store a respective P2L table 420 for the block 425. Additionally, or alternatively, one or more blocks 430 may include a set of memory cells that store a respective P2L table 420 for the block 430. A P2L table 420 may include a set of rows and a set of columns. Each row of a P2L table 420 may be associated with a physical address (e.g., a physical block address (PBA), of a block 425, of a block 430) implicitly, or may include a physical address indicator 405 that indicates a physical address, and each row may include a logical address indicator 410 (e.g., for a logical block address (LBA)) that corresponds to the physical address. The P2L table 420 may be an example of a data structure that is used to map LBAs to PBAs, where an LBA may be an example of an address that is used by a host system to access data stored in the memory system 210, and a PBA may be an example of a physical location of the data within the memory system 210 (e.g., a location of one or more memory cells, an indication of an address in a block 170 or other block unit). A P2L table 420 may be utilized to translate LBAs used by the host system into corresponding PBAs, which may allow the memory system 210 to retrieve data from a location of the memory system 210.

A P2L table 420 also may be used (e.g., by the memory system 210) to facilitate data transfer between one or more blocks 425 and one or more blocks 430. For example, each row of a P2L table may include an indication of a data characteristic, such as a stream ID 415 (e.g., for each PTU). In some cases, the stream ID 415 may be stored in one or more spare bits (e.g., one or more spare bits of a logical address indicator). In some cases, the memory system 210 may extract a bitmap associated with a particular data type by scanning the P2L table 420 using a bit mask, an exclusive-or (XOR) operation, or a zero check.

In some examples, transferring information may be based on a validity of the information (e.g., whether the information is valid or invalid). For example, the memory system 210 may selectively transfer valid information from a block 425 to a block 430, so that the block 425 may be made available for storing new information. In some cases, the memory system 210 may access a validity status for information from a storage location of the memory system 210.

In some cases, information may be transferred based on a data characteristic (e.g., a data type, a data temperature), which may be indicated by a stream ID 415 in a P2L table 420. For example, the memory system 210 may read one or more P2L tables 420 to select pages 230, codewords 435, or other data units having a specific data characteristic for a transfer operation, where such a selection may be performed without reading individual codewords 435 or pages 230. For example, the memory system 210 may prioritize transferring cold data 260 and, based on reading one or more P2L tables 420, may select the block 425-a, or pages 230 or codewords 435 thereof, among other data units that include cold data 260, for a transfer operation (e.g., prior to selecting pages 230 from the blocks 425-b, 425-c, and 425-d).

The memory system 210 may write transfer information to one or more blocks 430 in response to a size of the information (e.g., in SRAM, in a block 425) satisfying a threshold. For example, the memory system 210 may be configured to write specific quantities of pages 230 (e.g., specific burst sizes, specific granularities), such as a quantity of pages 230 in a block 430. A threshold write granularity for the memory system 210 may include any quantity of pages 230, which may be configured to support efficient transfer operations. For example, the memory system 210 may transfer a relatively small quantity of information (e.g., a single page 230, a page 230 associated with a size of pages in a block 430) from SRAM to one or more blocks 430 if the threshold write granularity (e.g., a single page 230) is satisfied. In some cases, a buffer may be dynamically allocated to different stream IDs, which may reduce a likelihood that deadlocks will occur and may improve storage efficiency at the SRAM.

Transferring data based on a stream ID 415 stored in a P2L table 420 may enable the memory system 110 to conserve processing resources by prioritizing the transfer of data from cold to hot (e.g., transferring cold data 260 prior to warm data 255) or by refraining from reading or transferring data with specific stream IDs 415 (e.g., refraining from reading or transferring hot data 250). For example, it may be advantageous for the memory system 210 to perform transfers on cold data 260 prior to performing transfers on warm data 255 or hot data 250, either or both of which may become invalid before the cold data 260 becomes invalid. Accordingly, the memory system 210 may perform a transfer operation that includes reading a data characteristic from a P2L table 420 to evaluate whether to read and transfer a codeword 435 (e.g., before reading the codeword 435), or to determine a target block 425 for a codeword 435, among other techniques. In some examples, such operations also may include reading information that indicates which codewords 435 or which pages 230 are valid. The memory system 210 may then write information that is valid to a block 430, which may be followed by marking one or more pages 230 of a block 425 as invalid or erasing a block 425.

In some cases, the memory system 210 may open one or more blocks 430 for each data characteristic, which may facilitate data separation at the memory system 210. For example, the memory system 210 may open the block 430-a for storing cold data 260, the block 430-b for storing warm data 255, the block 430-c for storing hot data, or any combination thereof. In some cases, the memory system 210 may determine a data characteristic allocation for blocks 430 (e.g., which blocks 430 allocated to respective data characteristics to open) based on information stored in the P2L table 420. For example, the memory system 210 may read one or more entries in the P2L table 420 and respective quantities of data stored in the memory system 210 corresponding to each stream ID 415. The memory system 210 may then open a block 430 for each stream ID 415 included in the P2L table 420, or a block 430 for each data characteristic having an amount of data that satisfies a threshold. Additionally, or alternatively, the memory system 210 may identify a characteristic of data for which to perform data transfers and accordingly open a respective block 430, or read corresponding pages 230 or codewords 435, or both based on stream IDs 415 stored in one or more P2L tables 420. By supporting stream IDs 415 in a separate location, such as in a P2L table (e.g., rather than in metadata 310 of codewords 315), the memory system 210 may avoid reading codewords 435 that are not candidates for a given media management operation, and also may reduce a quantity of blocks 430 that are open (e.g., supporting a more direct targeting of data with selected characteristics), which may reduce latency and processing resources used to perform such transfers.

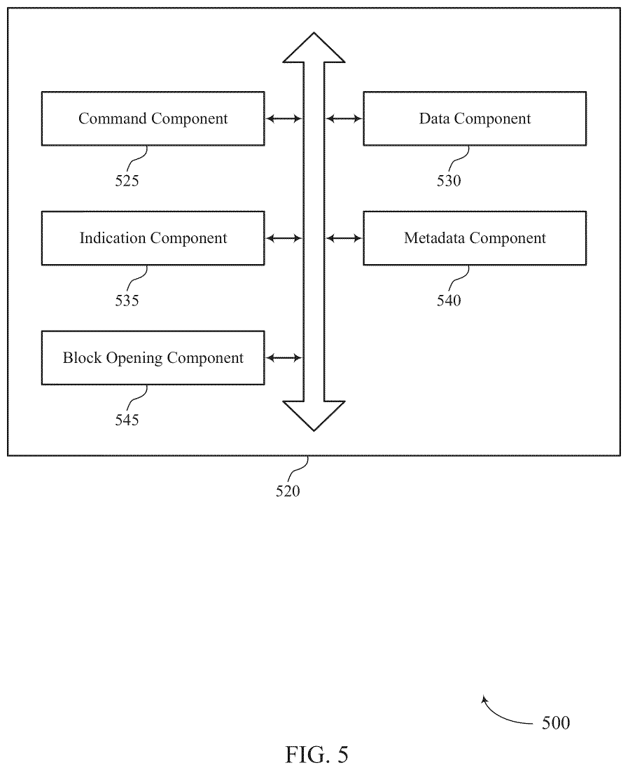

FIG. 5 illustrates a block diagram 500 of a memory system 520 that supports data type identification schemes in accordance with examples as disclosed herein. The memory system 520 may be an example of aspects of a memory system as described with reference to FIGS. 1 through 4. The memory system 520, or various components thereof, may be an example of means for performing various aspects of data type identification schemes for memory systems as described herein. For example, the memory system 520 may include a command component 525, a data component 530, an indication component 535, a metadata component 540, a block opening component 545, or any combination thereof. Each of these components may communicate, directly or indirectly, with one another (e.g., via one or more buses).

The command component 525 may be configured as or otherwise support a means for receiving a command to write data associated with a validity duration characteristic of the data. The data component 530 may be configured as or otherwise support a means for writing the data to one or more first memory cells of a block of memory cells of the memory system 520. The indication component 535 may be configured as or otherwise support a means for writing an indication of the validity duration characteristic of the data to one or more second memory cells of the memory system 520 that are associated with the block of memory cells.

In some examples, to support writing the indication of the validity duration characteristic, the indication component 535 may be configured as or otherwise support a means for writing the indication of the validity duration characteristic in a field of a physical-to-logical address table associated with the block of memory cells.

In some examples, the block of memory cells includes the one or more second memory cells. In some examples, the metadata component 540 may be configured as or otherwise support a means for writing metadata associated with the data to the block of memory cells, and the metadata associated with the data may include the indication of the validity duration characteristic of the data.

In some examples, the command component 525 may be configured as or otherwise support a means for receiving a second command to write second data associated with a second validity duration characteristic of the second data, the second validity duration characteristic being different than the first validity duration characteristic. In some examples, the data component 530 may be configured as or otherwise support a means for writing the second data to one or more third memory cells of the block of memory cells. In some examples, the indication component 535 may be configured as or otherwise support a means for writing a second indication of the second validity duration characteristic of the second data to one or more fourth memory cells that are associated with the block of memory cells.

In some examples, the data component 530 may be configured as or otherwise support a means for writing the data, based at least in part on reading the data from the one or more first memory cells, to one or more fifth memory cells of a second block of memory cells of the memory system 520. In some examples, the indication component 535 may be configured as or otherwise support a means for writing a third indication of the validity duration characteristic, based at least in part on reading the one or more second memory cells, to one or more sixth memory cells that are associated with the second block of memory cells.

In some examples, writing the data to the one or more fifth memory cells may be based at least in part on a quantity of data stored at the memory system 520 and associated with the validity duration characteristic satisfying a threshold.

In some examples, memory cells of the block of memory cells may be configured in accordance with a first storage density configuration and memory cells of the second block of memory cells may be configured in accordance with a second storage density configuration that is different than the first storage density configuration.

In some examples, the block opening component 545 may be configured as or otherwise support a means for opening the second block of memory cells based at least in part on the validity duration characteristic, and writing the data to the one or more fifth memory cells of the second block of memory cells may be based at least in part on opening the second block of memory cells. In some examples, reading the data from the one or more first memory cells may be based at least in part on reading the indication of the validity duration characteristic of the data from the one or more second memory cells.

In some examples, the one or more first memory cells and the one or more second memory cells may be associated with a codeword stored in the block of memory cells. In some examples, writing the data to the one or more fifth memory cells may be based at least in part on reading the data and the indication of the validity duration characteristic from the codeword stored in the block of memory cells. In some examples, the block opening component 545 may be configured as or otherwise support a means for opening a plurality of blocks of memory cells including the second block of memory cells, each block of memory cells of the plurality of blocks of memory cells associated with a different validity duration characteristic, and writing the data to the one or more fifth memory cells of the second block of memory cells may be based at least in part on opening the plurality of blocks of memory cells.

In some examples, the one or more second memory cells include one or more not-and (NAND) memory cells. In some examples, the one or more second memory cells include one or more static random access memory (SRAM) memory cells.

In some examples, the validity duration characteristic may be associated with a duration for which the data is anticipated to be valid at the memory system. In some examples, the validity duration characteristic may be associated with a rate of invalidation of the data. In some examples, indication of the validity duration characteristic may include a stream identifier associated with the data.

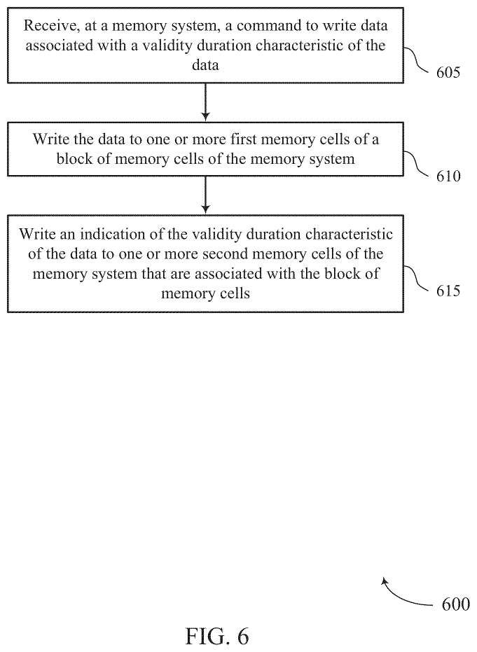

FIG. 6 illustrates a flowchart showing a method 600 that supports data type identification schemes for memory systems in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include receiving, at a memory system, a command to write data associated with a validity duration characteristic of the data. In some examples, aspects of the operations of 605 may be performed by a command component 525 as described with reference to FIG. 5.

At 610, the method may include writing the data to one or more first memory cells of a block of memory cells of the memory system. In some examples, aspects of the operations of 610 may be performed by a data component 530 as described with reference to FIG. 5.

At 615, the method may include writing an indication of the validity duration characteristic of the data to one or more second memory cells of the memory system that are associated with the block of memory cells. In some examples, aspects of the operations of 615 may be performed by an indication component 535 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for receiving, at a memory system, a command to write data associated with a validity duration characteristic of the data; writing the data to one or more first memory cells of a block of memory cells of the memory system; and writing an indication of the validity duration characteristic of the data to one or more second memory cells of the memory system that are associated with the block of memory cells.
Aspect 2: The method, apparatus, or non-transitory computer-readable medium of aspect 1, where writing the indication of the validity duration characteristic includes operations, features, circuitry, logic, means, or instructions, or any combination thereof for writing the indication of the validity duration characteristic in a field of a physical-to-logical address table associated with the block of memory cells.
Aspect 3: The method, apparatus, or non-transitory computer-readable medium of any of aspects 1 through 2, where the block of memory cells includes the one or more second memory cells.
Aspect 4: The method, apparatus, or non-transitory computer-readable medium of aspect 3, further including operations, features, circuitry, logic, means, or instructions, or any combination thereof for writing metadata associated with the data to the block of memory cells, where the metadata associated with the data includes the indication of the validity duration characteristic of the data.
Aspect 5: The method, apparatus, or non-transitory computer-readable medium of any of aspects 1 through 4, further including operations, features, circuitry, logic, means, or instructions, or any combination thereof for receiving, at the memory system, a second command to write second data associated with a second validity duration characteristic of the second data, the second validity duration characteristic being different than the first validity duration characteristic; writing the second data to one or more third memory cells of the block of memory cells; and writing a second indication of the second validity duration characteristic of the second data to one or more fourth memory cells that are associated with the block of memory cells.
Aspect 6: The method, apparatus, or non-transitory computer-readable medium of any of aspects 1 through 5, further including operations, features, circuitry, logic, means, or instructions, or any combination thereof for writing the data, based at least in part on reading the data from the one or more first memory cells, to one or more fifth memory cells of a second block of memory cells of the memory system and writing a third indication of the validity duration characteristic, based at least in part on reading the one or more second memory cells, to one or more sixth memory cells that are associated with the second block of memory cells.
Aspect 7: The method, apparatus, or non-transitory computer-readable medium of aspect 6, where writing the data to the one or more fifth memory cells is based at least in part on a quantity of data stored at the memory system and associated with the validity duration characteristic satisfying a threshold.
Aspect 8: The method, apparatus, or non-transitory computer-readable medium of any of aspects 6 through 7, where memory cells of the block of memory cells are configured in accordance with a first storage density configuration and memory cells of the second block of memory cells are configured in accordance with a second storage density configuration that is different than the first storage density configuration.
Aspect 9: The method, apparatus, or non-transitory computer-readable medium of any of aspects 6 through 8, further including operations, features, circuitry, logic, means, or instructions, or any combination thereof for opening the second block of memory cells based at least in part on the validity duration characteristic, where writing the data to the one or more fifth memory cells of the second block of memory cells is based at least in part on opening the second block of memory cells.
Aspect 10: The method, apparatus, or non-transitory computer-readable medium of aspect 9, where reading the data from the one or more first memory cells is based at least in part on reading the indication of the validity duration characteristic of the data from the one or more second memory cells.
Aspect 11: The method, apparatus, or non-transitory computer-readable medium of any of aspects 6 through 10, where the one or more first memory cells and the one or more second memory cells are associated with a codeword stored in the block of memory cells and writing the data to the one or more fifth memory cells is based at least in part on reading the data and the indication of the validity duration characteristic from the codeword stored in the block of memory cells.
Aspect 12: The method, apparatus, or non-transitory computer-readable medium of aspect 11, further including operations, features, circuitry, logic, means, or instructions, or any combination thereof for opening a plurality of blocks of memory cells including the second block of memory cells, each block of memory cells of the plurality of blocks of memory cells associated with a different validity duration characteristic, where writing the data to the one or more fifth memory cells of the second block of memory cells is based at least in part on opening the plurality of blocks of memory cells.
Aspect 13: The method, apparatus, or non-transitory computer-readable medium of any of aspects 1 through 12, where the one or more second memory cells include one or more not-and (NAND) memory cells.
Aspect 14: The method, apparatus, or non-transitory computer-readable medium of any of aspects 1 through 13, where the one or more second memory cells include one or more static random access memory (SRAM) memory cells.
Aspect 15: The method, apparatus, or non-transitory computer-readable medium of any of aspects 1 through 14, where the validity duration characteristic is associated with a duration for which the data is anticipated to be valid at the memory system.
Aspect 16: The method, apparatus, or non-transitory computer-readable medium of any of aspects 1 through 15, where the validity duration characteristic is associated with a rate of invalidation of the data.
Aspect 17: The method, apparatus, or non-transitory computer-readable medium of any of aspects 1 through 16, where indication of the validity duration characteristic includes a stream identifier associated with the data.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memory devices; and
a controller coupled with the one or more memory devices and configured to cause the apparatus to:
receive a command to write data associated with a validity duration characteristic of the data;
write the data to one or more first memory cells of a block of memory cells of the one or more memory devices; and
write an indication of the validity duration characteristic of the data to one or more second memory cells of the one or more memory devices that are associated with the block of memory cells.

2. The apparatus of claim 1, wherein, to write the indication of the validity duration characteristic, the controller is configured to cause the apparatus to:
write the indication of the validity duration characteristic in a field of a physical-to-logical address table associated with the block of memory cells.

3. The apparatus of claim 1, wherein the block of memory cells comprises the one or more second memory cells.

4. The apparatus of claim 3, wherein the controller is further configured to cause the apparatus to:
write metadata associated with the data to the block of memory cells, wherein the metadata associated with the data comprises the indication of the validity duration characteristic of the data.

5. The apparatus of claim 1, wherein the controller is further configured to cause the apparatus to:
receive a second command to write second data associated with a second validity duration characteristic of the second data, the second validity duration characteristic being different than the validity duration characteristic;
write the second data to one or more third memory cells of the block of memory cells; and
write a second indication of the second validity duration characteristic of the second data to one or more fourth memory cells that are associated with the block of memory cells.

6. The apparatus of claim 1, wherein the controller is further configured to cause the apparatus to:
write the data, based at least in part on reading the data from the one or more first memory cells, to one or more fifth memory cells of a second block of memory cells of the one or more memory devices; and
write a third indication of the validity duration characteristic, based at least in part on reading the one or more second memory cells, to one or more sixth memory cells that are associated with the second block of memory cells.

7. The apparatus of claim 6, wherein the controller is further configured to cause the apparatus to:
write the data to the one or more fifth memory cells based at least in part on a quantity of data stored at the one or more memory devices and associated with the validity duration characteristic satisfying a threshold.

8. The apparatus of claim 6, wherein memory cells of the block of memory cells are configured in accordance with a first storage density configuration and memory cells of the second block of memory cells are configured in accordance with a second storage density configuration that is different than the first storage density configuration.

9. The apparatus of claim 6, wherein the controller is further configured to cause the apparatus to:
open the second block of memory cells based at least in part on the validity duration characteristic, wherein writing the data to the one or more fifth memory cells of the second block of memory cells is based at least in part on opening the second block of memory cells.

10. The apparatus of claim 9, wherein the controller is further configured to cause the apparatus to:
read the data from the one or more first memory cells based at least in part on reading the indication of the validity duration characteristic of the data from the one or more second memory cells.

11. The apparatus of claim 6, wherein the one or more first memory cells and the one or more second memory cells are associated with a codeword stored in the block of memory cells, and wherein the controller is further configured to cause the apparatus to:
write the data to the one or more fifth memory cells based at least in part on reading the data and the indication of the validity duration characteristic from the codeword stored in the block of memory cells.

12. The apparatus of claim 11, wherein the controller is further configured to cause the apparatus to:
open a plurality of blocks of memory cells including the second block of memory cells, each block of memory cells of the plurality of blocks of memory cells associated with a different validity duration characteristic; and
write the data to the one or more fifth memory cells of the second block of memory cells based at least in part on opening the plurality of blocks of memory cells.

13. The apparatus of claim 1, wherein the validity duration characteristic is associated with a duration for which the data is anticipated to be valid.

14. The apparatus of claim 1, wherein the validity duration characteristic is associated with a rate of invalidation of the data.

15. The apparatus of claim 1, wherein indication of the validity duration characteristic comprises a stream identifier associated with the data.

16. A non-transitory computer-readable medium storing code comprising instructions which, when executed by a processor of an electronic device, cause the electronic device to:
receive, at a memory system, a command to write data associated with a validity duration characteristic of the data;
write the data to one or more first memory cells of a block of memory cells of the memory system; and
write an indication of the validity duration characteristic of the data to one or more second memory cells of the memory system that are associated with the block of memory cells.

17. The non-transitory computer-readable medium of claim 16, wherein the instructions to write the indication of the validity duration characteristic, when executed by the processor of the electronic device, cause the electronic device to:
write the indication of the validity duration characteristic in a field of a physical-to-logical address table associated with the block of memory cells.

18. The non-transitory computer-readable medium of claim 16, wherein the block of memory cells comprises the one or more second memory cells.

19. The non-transitory computer-readable medium of claim 18, wherein the instructions, when executed by the processor of the electronic device, further cause the electronic device to:
write metadata associated with the data to the block of memory cells, wherein the metadata associated with the data comprises the indication of the validity duration characteristic of the data.

20. A method, comprising:
receiving, at a memory system, a command to write data associated with a validity duration characteristic of the data;
writing the data to one or more first memory cells of a block of memory cells of the memory system; and
writing an indication of the validity duration characteristic of the data to one or more second memory cells of the memory system that are associated with the block of memory cells.
